(19) United States
(12) Patent Application Publication
(10) Pub. No.: US 2006/0068748 A1
(43) Pub. Date: Mar. 30, 2006

(54) Communication semiconductor integrated circuit and radio communication system

(76) Inventors: Kiyoshi Irie, Yokohama (JP); Kazuaki Hori, Yokohama (JP); Hiroshi Mori, Takasaki (JP); Stephen Goodwin, Hertfordshire (GB)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/176,302

(22) Filed: Jul. 8, 2005

(30) Foreign Application Priority Data
Sep. 29, 2004 (GB) 0421621.4

(51) Int. Cl. H04B 1/40; H04B 1/28; H04M 1/00

(52) U.S. Cl. 455/333; 455/550.1; 455/88

(57) ABSTRACT

A direct upconversion system communication semiconductor integrated circuit includes a frequency converter circuit for up-converting a transmission signal and a notch filter located at a subsequent stage of the frequency converter circuit. The notch filter is served to cut off at least third-order harmonics of a local signal.

### INCORPORATION BY REFERENCE

The present application claims priority from U.K. patent application No. 0421621.4 filed on Sep. 29, 2004, the content of which is hereby incorporated by reference into this application.

### BACKGROUND OF THE INVENTION

The present invention relates to a technology that may be effectively applied to a filtering circuit for removing harmonic components contained in a transmission signal modulated in a communication semiconductor integrated circuit (high frequency IC) composing a radio communication system. More particularly, the invention relates to the technology that may be effectively applied to a communication semiconductor integrated circuit of a direct upconversion system arranged to directly convert a transmission signal of a baseband frequency band into a signal of a transmission frequency band.

The radio communication system such as a portable phone uses a communication semiconductor integrated circuit (referred to as a high frequency IC) that is arranged to synthesize a receiving signal or a transmission signal with a local oscillation signal (simply referred to as a local signal) of a high frequency for upconverting or downconverting the frequency or modulate the transmission signal or demodulate the receiving signal.

As such a high frequency IC, there has been proposed a super heterodyne system high frequency IC (see U.S. Pat. No. 6,384,676) that is arranged to temporarily convert the transmission signal of a baseband frequency band into a signal of an intermediate frequency and then convert the intermediate frequency signal into the signal of the transmission frequency band or a so-called offset PLL system high frequency IC (see GB2393050A) that is arranged to modulate the oscillation signal of an intermediate frequency with the transmission signal, synthesize a feedback signal from a transmitting VCO with the oscillation signal of a RF-VCO for generating a signal of the intermediate frequency, and compare this signal with the modulated signal in phase for generating the oscillation control signal for controlling the transmitting VCO.

The super heterodyne system high frequency IC or the offset PLL system high frequency IC requires an oscillator circuit (IFVCO) for generating an oscillation signal of an intermediate frequency (herein, also referred to as a local signal) and a mixer circuit for frequency conversion. Hence, these high frequency IC's require large scale so that the chip size may be increased and thereby the chip cost may be made higher.

Further, the super heterodyne system high frequency IC is arranged to temporarily convert the transmission signal into a signal of the intermediate frequency. This arrangement often provides a SAW filter for removing unnecessary signal components contained in the signal of the intermediate frequency. In this case, therefore, the number of external components attached to the IC chip increases, so that the reduction of the system in size may be made difficult. It means that the direct upconversion system high frequency IC is effective in the reduction of the system in cost and size.

### SUMMARY OF THE INVENTION

For the direct upconversion system high frequency IC, it is preferable to use not a sinusoidal wave but a square wave as a local signal (carrier) to be applied into a mixer circuit for frequency conversion. This is because the round waveform of the local signal causes a transistor composing a differential stage of the mixer circuit to be slowly switched on and off, so that the noises contained in the local signal may appear in the output of the mixer during the slow switching. On the other hand, the use of the square wave as the local signal causes the differential transistor of the mixer circuit to be quickly switched, so that the appearance of the noises contained in the local signal in the output of the mixer may be avoided.

However, as well known, the square wave contains lots of third-order and fifth-order, that is, odd number harmonic components. Hence, these harmonic components are put on the output of the mixer. When these harmonic components are inputted into the amplifier circuit (output amplifier) located at the next stage, the waveform of the transmission signal is distorted. In order to reduce the distortion of this output waveform, it is necessary to spread the dynamic range of the amplifier circuit located at the next stage. This leads to increasing the power consumption of the output amplifier.

Further, the variations in production may cause the symmetry of the mixer to be inferior and the ratio accuracy of the elements composing the mixer to be degraded, when the second-order harmonics appear in the output of the mixer. The frequency difference between this second-order harmonics and the third-order harmonics of the local signal is the same as the frequency of the local signal. It thus means that the output waveform is disadvantageously distorted by the inter-modulation effect of these harmonics.

By the way, as the heretofore proposed portable phones, there may be referred a GSM (Global System for Mobile Communication) portable phone that uses the TDMA (Time Division Multiple Access) system as a multiplex system and the GMSK (Gaussian Minimum Shift Keying) as the modulation system or a DCS (Digital Cellular System) portable phone of 1800 MHz band as well as a CDMA (Code Division Multiple Access) portable phone that uses the spectrum diffusion system as the multiplex system and the QPSK (Quadrature PSK) as the modulation system. In these types of portable phones, the CDMA portable phone includes the high frequency IC that consumes much electric power because the portable phone performs the reception and the transmission at a time, while the GSM and DCS portable phones do not consume so much electric power because these types of portable phones perform the transmission and the reception in time division. Hence, it is preferable to more reduce the power consumption of the high frequency IC. It means that it is important to remove the harmonic components contained in the local signal for reducing the power consumption of the output amplifier with a relatively large power consumption in a chip.

Under these circumstances, the present inventors have studied provision of a general low-pass filter at a later stage of the mixer for the purpose of removing the harmonic components contained in the local signal. As a result, it is found that the use of a high-order filter is required for removing the second-order harmonics and the higher-order ones with the low-pass filter. However, the use of the high-order filter makes the occupation area of the low-pass filter larger, in spite of removing the IFVCO by the use of the direct upconversion system. It is thus understood that the sufficient reduction of the high frequency IC in size cannot be achieved.

In the foregoing background, it is an object of the present invention to provide a direct upconversion system communication semiconductor integrated circuit (high frequency IC) that is arranged to reduce consumed current and distortion of transmitting signal by sufficiently removing higher harmonics.

It is a further object of the present invention to provide a direct upconversion system communication semiconductor integrated circuit (high frequency IC) that is arranged to reduce its chip in size and the number of external components attached to the chip and to miniaturize the overall system.

The foregoing and the other objects and the novel features of this invention will be apparent from the description of this specification and the appended drawings.

In carrying out the objects, the representative invention disclosed in the present application will be described as below.

A direct upconversion system communication semiconductor integrated circuit (high frequency IC) provides a notch filter for cutting off third-order harmonics of at least the local signal located at a later stage of a frequency converter circuit (mixer) for upconverting the transmission signal. Herein, if a transmission amplifier for amplifying a transmission signal is located at a subsequent stage of a frequency converter circuit for upconverting the transmission signal, it is preferable to locate the notch filter between the frequency converter circuit and the transmission amplifier.

More preferably, in addition to the notch filter for cutting off the third-order harmonics, another notch filter for cutting off fifth-order or second-order harmonics may be provided. Further, if the notch filter is composed of elements on a single chip, in addition to those notch filters, a low-pass filter may be provided. Specifically, in the case of using a trap filter arranged to use an LC resonance circuit as the notch filter and forming an inductor on a chip, it is more preferable to provide the low-pass filter.

By the foregoing arrangement, if the square wave may be used as the local signal, it is possible to prevent the harmonic components contained in the local signal from being mixed into the output of the mixer and then being applied into the output amplifier located at the subsequent stage, which may avoid distortion of the waveform of the transmission signal. This does not require the output amplifier with an wider dynamic range for the purpose of reducing distortion of the waveform of the transmission signal and may lower the power consumption. Further, the use of the inductor formed on a chip does not provide the resonance circuit with sufficiently high Q value, thereby being unable to sufficiently remove the target harmonics by the filtering characteristics provided by only the trap filter. However, the unnecessary signal components that cannot be sufficiently removed by the trap filter may be eliminated by the low-pass filter.

Moreover, the variation in production causes the symmetry of the mixer to be inferior and the characteristics of the transistors composing the mixer to be degraded. As a result, the second-order harmonics may appear in the output of the mixer. Even in this case, these second-order harmonics are cut off by the notch filter. This thus prevents the output waveform from being distorted by the inter-modulation effect of the second-order and the third-order harmonics.

Further, the present invention is effective in the arrangement wherein a Gilbert cell circuit composed of a pair of differential transistors in vertical arrangement is used as the frequency converter circuit (mixer), the local signal is applied into the upper differential transistors for switching the signal on and off, the I and the Q signals are applied into the lower differential transistors, and then the orthogonally transformed signal is outputted.

With the square wave as the local signal, it is possible to switch the upper differential transistors included in the Gilbert cell circuit quickly and avoid the mixture of the noises contained in the local signal with the output of the mixer. Then, the use of the square wave as the local signal allows the third-order or the fifth-order, that is, the high-order harmonics appearing in the output to be removed by the notch filter located at the subsequent stage. This results in improving the total characteristics and reducing the distortion of the output waveform in size.

The effects obtained by the representative invention disclosed by the present application will be briefly described as below.

The invention provides the direct upconversion system communication semiconductor integrated circuit (high frequency IC) for lowering the power consumption, sufficiently removing the harmonics, and thereby reducing the distortion of the transmission signal in size.

Further, the present invention may realize the direct upconversion system communication semiconductor integrated circuit (high frequency IC) that is arranged to make the chip size smaller, reduce the number of external components attached to the IC chip, and miniaturize the overall system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a schematic arrangement of a radio communication system like a portable phone provided with a direct upconversion system transmission circuit and a high frequency IC used for the radio communication system;

FIG. 2 is a graph showing a characteristic of a filter circuit composed of a low-pass filter and a notch filter provided at a later stage of a quadrature modulating circuit on the transmission side;

FIGS. 3A and 3B are circuit diagrams showing a concrete filter circuit of the filter circuit located at a later stage of the quadrature modulation on the transmission side, in which FIG. 3A is a circuit diagram showing a concrete arrangement of the low-pass filter and FIG. 3B is a circuit diagram showing a concrete arrangement of the notch filter;

FIG. 4 is a graph showing a spectrum of a local signal provided when the square wave is used as the orthogonal signal;

FIG. 5 is a graph showing a spectrum of an output signal of an quadrature modulating circuit according to this embodiment of the invention;

FIG. 6 is a block diagram showing an arrangement of a filter circuit located at a subsequent stage of an quadrature modulating circuit on the transmission side according to the second embodiment of the invention;

FIG. 7 is a block diagram showing an exemplary transformation of the filter circuit included in the second embodiment;

FIG. 8 is a block diagram showing an arrangement of the filter circuit located at a later stage of the quadrature modulating circuit on the transmission side included in the second embodiment of the invention; and

FIG. 9 is a circuit diagram showing a concrete arrangement of a quadrature modulation circuit on the transmitting side.

### DESCRIPTION OF THE EMBODIMENTS

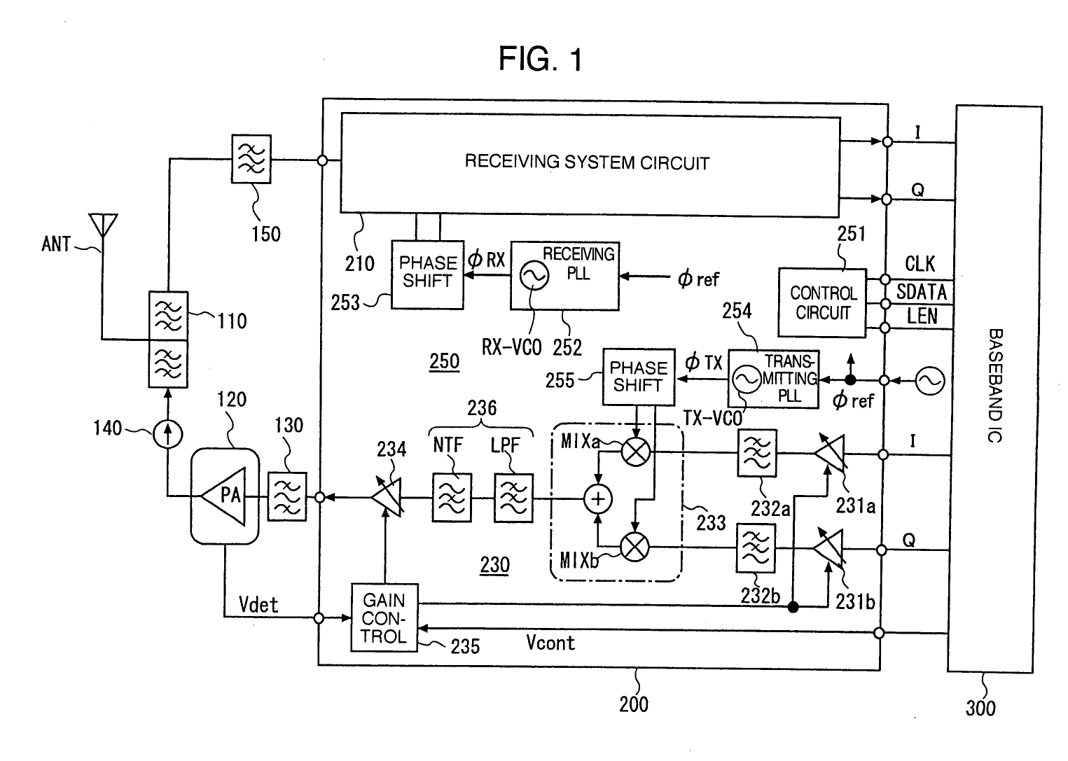

FIG. 1 is a block diagram showing an exemplary arrangement of a communication semiconductor integrated circuit (high frequency IC) to which the first embodiment of the present invention is applied and a radio communication system with the high frequency IC applied thereto.

The radio communication system shown in FIG. 1 is arranged to have an antenna ANT for transmitting or receiving a signal wave, a duplexer 110 for separating the signal into a transmission signal and a receiving signal, a high frequency power amplifier 120 for power amplifying the transmission signal and outputting the amplified signal to the antenna, a transmission side band-pass filter 130 having a SAW filter for removing unnecessary waves from the transmission signal, an isolator 140 for cutting off return of a reflected wave on the antenna end to the power amplifier, a receiving side band-pass filter 150 having a SAW filter for removing unnecessary waves from the receiving signal, a high frequency IC 200 for demodulating and downconverting the receiving signal or modulating and upconverting the receiving signal, and a baseband circuit 300 for performing a baseband process of converting a fundamental wave into an I signal of an in-phase component and a Q signal of a quadrature component or converting the demodulated received I and Q signals into the speech signal and the data signal and then transmitting a signal for controlling the high frequency IC 200.

Though not specifically restricted, each of the high frequency IC 200 and the baseband circuit 300 is formed as a semiconductor integrated circuit on the individual semiconductor chip. The specific arrangement of the high frequency IC 200 may often make the band-pass filters 130 and 150 unnecessary.

In this embodiment, the high frequency IC 200 may be roughly divided into a receiving system circuit 210, a transmitting system circuit 230, and a control system circuit 250 that is common to both of the receiving and the transmitting systems. Though not specifically restricted, the transmitting system circuit 230 is composed of a direct conversion system circuit of directly upconverting the transmission signal of a speech frequency band into the signal of a transmission frequency of a final carrier wave. Though not shown, the receiving system circuit 210 is composed of a direct conversion system circuit of directly downconverting the receiving signal into the signal of a speech frequency band.

The control system circuit 250 is arranged to have a control circuit 251 for generating a control signal inside a chip, a receiving PLL circuit 252 having a local oscillator RX-VCO and for generating a receiving side local signal φRX, a phase-shift circuit 253 for phase-shifting the signal φRX and thereby generating orthogonal signals whose phases are different from each other by 90 degrees, a transmitting PLL circuit 254 having a local oscillator TX-VCO and for generating a transmitting side local signal φTX, and a phase-shift circuit 255 for phase-shifting φTX and thereby generating orthogonal signals whose phases are different from each other by 90 degrees. The receiving PLL circuit 252 or the transmitting PLL circuit 254 may be composed of a VCO, a frequency divider circuit, a phase comparator circuit, a charge pump, a loop filter, and so forth.

Also in this embodiment, the high frequency IC 200 is equipped with an input terminal that is inputted with a reference signal φref supplied from the outside. The reference signal φref is supplied to the receiving PLL circuit 252 and the transmitting PLL circuit 254. In each PLL phase comparator circuit, the reference signal φref is compared with a feedback signal sent from the VCO and is locked with a preferable oscillating frequency. In place of the external supply of the reference signal φref, it is possible to provide an oscillator circuit for generating the reference signal φref inside the chip and to use a quartz oscillator attached outside as its vibrator.

The control circuit 251 is supplied with a synchronizing clock signal CLK from the baseband circuit 300, a data signal SDATA, and a load enable signal LEN as its control signal. When the load enable signal LEN is asserted on an effective level, the control circuit 251 sequentially acquires the data signal SDATA being transmitted from the baseband circuit 300 in synchronization with the clock signal CLK and then generates the control signal inside the chip in response to a command contained in the data signal SDATA. Though not specifically restricted, the data signal SDATA is serially transmitted.

Though not illustrated, the receiving system circuit 210 is arranged to have a low noise amplifier for amplifying a receiving signal, a demodulating & frequency converting unit composed of a mixer circuit of mixing the receiving signal amplified by the low noise amplifier with the orthogonal signals generated by the frequency divider circuit 253 for performing demodulation and downconversion, a high gain amplifier circuit for amplifying the demodulated I and Q signals and then outputting the amplified signals to the baseband circuit 300, and a low-pass filter for removing unnecessary waves from the amplified signals.

The transmitting system circuit 230 is arranged to have input circuits 231a and 231b each of which is composed of a variable gain amplifier for amplifying the I signal or the Q signal supplied from the baseband circuit 300, low-pass filters 232a and 232b for removing harmonic components from the amplified I and Q signals, a modulation & frequency conversion unit 233 composed of mixers MIXa and MIXb for synthesizing the filtered I and Q signals with the orthogonal signals whose phases are different from each other by 90 degrees, which signals are supplied from the transmitting PLL circuit 254 and the phase-shift circuit 255, for performing quadrature modulation and upconversion, an output amplifier 234 for amplifying the modulated signal and then outputting the amplified signal, and a gain control circuit 235 for controlling the gains of the output amplifier 234 and the variable gain amplifiers 231a and 231b so that an output signal is adjusted to a preferable level with an output level control signal Vcont supplied from the baseband circuit 300 and an output detection signal Vdet fed back from the power amplifier 120.

The low-pass filters 232a and 232b are provided for removing distortion (harmonic components) brought about when the I and Q signals pass the circuits 231a and 231b and noises outside the frequency band. Preferably, these low-pass filters may be second-order or higher order filters.

In the high frequency IC 200 of this embodiment, between the modulation & frequency conversion unit 233 of the transmitting system circuit 230 and the output amplifier 234 is located a filter circuit 236 composed of a low-pass filter LPF and a notch filter NTF.

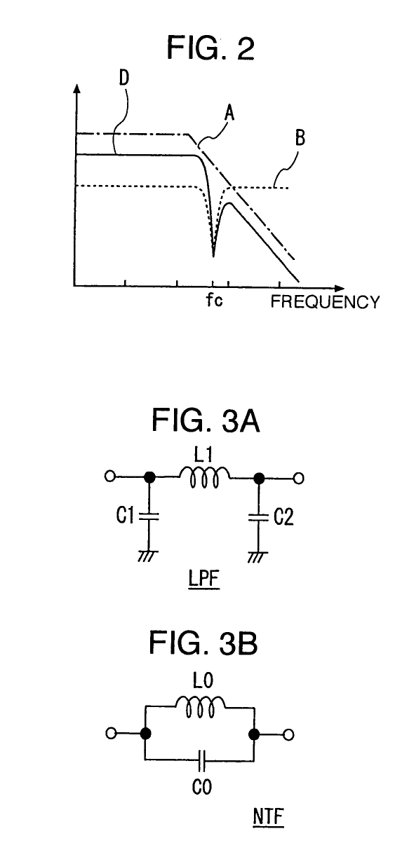

FIG. 2 shows a frequency characteristic of the filter circuit 236 composed of the low-pass filter LPF and the notch filter NTF. In FIG. 2, an alternate long and short dash line A indicates the characteristic of the low-pass filter LPF, a broken line indicates the characteristic of the notch filter NTF, and a real line D indicates the synthetic characteristic of these filters, that is, the frequency characteristic of the filter circuit 236.

FIG. 3A shows a concrete circuit of the low-pass filter LPF. FIG. 3B shows a concrete circuit of the notch filter NTF. In this embodiment, the low-pass filter LPF is composed of an inductor L1 and two capacitors C1 and C2. The notch filter NTF is an LC resonance type trap filter composed of an inductor L0 and a capacitor C0 connected in parallel. In place, a CR type filter circuit composed of a resistor element and a capacitance element may be used for each of these filters.

Though not specifically restricted, in this embodiment, the elements L1, C2, C2, L0, and C0 composing the low-pass filter LPF or the notch filter NTF are all on-chip elements. For making the Q value higher, it is better to use a discrete element for the inductor L0 so that the discrete element is connected with an external terminal provided with the chip. This may offer a notch filter with a more excellent characteristic. In this embodiment, however, all elements composing the filter circuit 236 are on-chip elements.

The use of the on-chip inductor does not make it possible to offer a sufficiently high Q value. Hence, the filter characteristic of only the trap filter is not enough high to completely remove the target harmonics. In this embodiment, on the other hand, the filter circuit 236 is composed of the trap filter and the low-pass filter. Hence, the low-pass filter enables to remove the unnecessary signal components that cannot be removed by the trap filter.

The arrangement of the two filters is not limited to the arrangement shown in FIG. 1, that is, the arrangement may be in order of the low-pass filter and the notch filter. In place, it may be the sequence of the notch filter and the low-pass filter. Further, FIGS. 3A and 3B are circuits of the low-pas filter and the notch filter separated from each other. Instead, the low-pass filter and the notch filter may be combined into one circuit. The combined circuit is composed of a capacitor located between differential output lines of the modulation & frequency converter circuit 233, a pair of inductors located on the differential output lines respectively, a pair of capacitors located in parallel to these inductors respectively, and a capacitor located between the output side nodes of the inductors.

In the case of the WCDM (Wideband CDMA) system portable phone, the frequency band of the transmission signal is about 2 GHz (1920 to 1980 MHz) and the band width is 5 MHz. On the other hand, the frequency of the I and Q signals supplied from the baseband circuit 300 to the high frequency IC 200 is about 2 MHz. Hence, the frequency of the local signal stays in the range of 1920 to 1980 MHz±2 MHz. In this embodiment, therefore, the cutoff frequency of the notch filter NTF is about 6 GHz, and the cutoff frequency of the low-pass filter LPF ranges from 2 to 4 GHz.

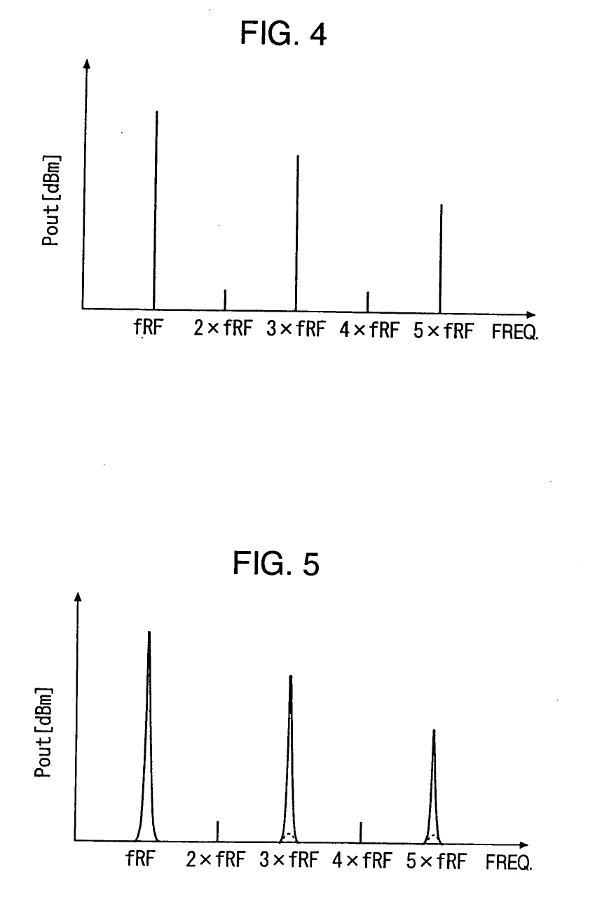

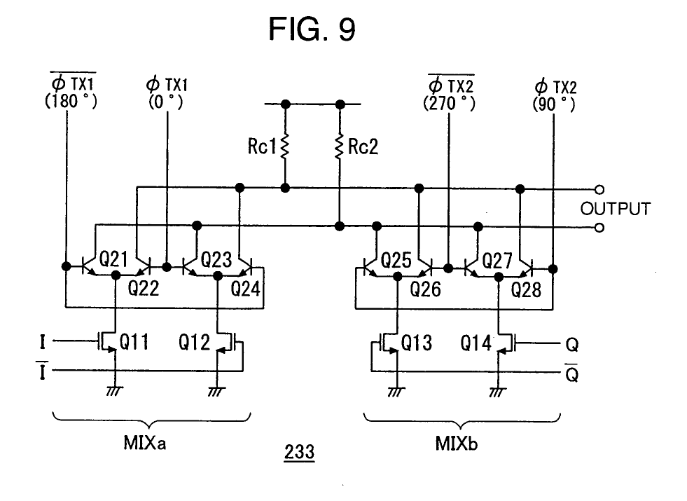

FIG. 4 shows a spectrum diagram of the local signal derived from the following arrangement. As the quadrature modulating mixers MIXa and MIXb are used the Gilbert cell type quadrature modulating circuit as shown in FIG. 9 arranged to vertically locate a pair of differential transistors between the supply power Vcc and the ground GND. The orthogonal signals φTX1/φTX1 and φTX2/φTX2 are applied into the upper differential transistors Q21 to Q28 for switching these transistors and the I and the Q signals are applied into the lower differential transistors Q11 to Q14 so that these transistors may output the orthogonally modulated signal. The square wave is used as the orthogonal signal. Further, FIG. 5 shows a spectrum diagram of an output signal of the quadrature modulating circuit.

As shown in FIG. 4, if the square wave is used as the local signal, the local signal contains lots of third-order or fifth-order, that is, odd number order harmonics. Also as shown in FIG. 4, hence, the output signal of the quadrature modulating circuit 233 contains lots of third-order or fifth-order harmonics. The third-order harmonics are substantially removed by the notch filter located at a later stage. The fifth-order harmonics are substantially removed by the low-pass filter. As shown by the broken line, the third-order and the fifth-order harmonics are suppressed. As a result, the harmonic components are not inputted into the variable gain amplifier 234 served as an output amplifier located at a later stage. Hence, even if the dynamic range of the variable gain amplifier 234 is made half or less as low as that in the case of providing no filter circuit 236, the waveform distortion of the transmission signal may be suppressed and thereby the power consumption may be reduced.

### Second Embodiment

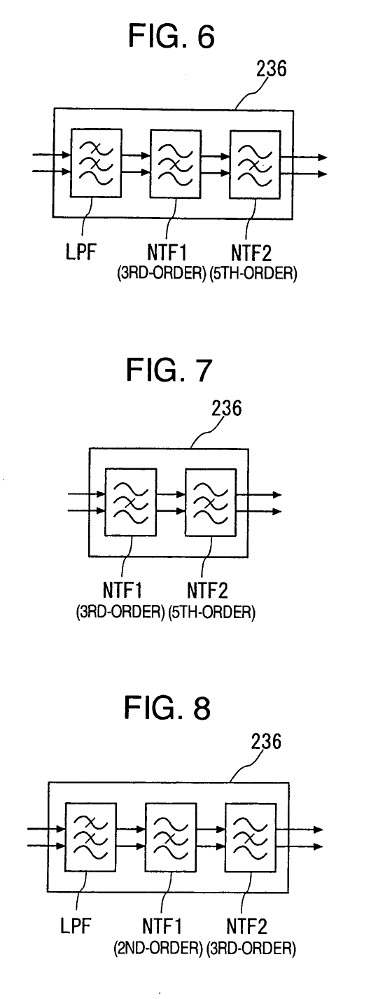

FIG. 6 shows the second embodiment of the present invention. In this embodiment, the filter circuit 236 located at a subsequent stage of the quadrature modulating circuit 233 is composed of one low-pass filters LPF and two notch filters NTF1 and NTF2. One of these notch filters NTF1 has a cutoff frequency specified so as to remove the third-order harmonics of the local signal. The other notch filter NTF2 has a cutoff frequency specified so as to remove the fifth-order harmonics of the local signal. In a case that the transistors composing the quadrature modulating circuit 222 and the transistors composing the phase-shift circuit 255 offer excellent frequency characteristics, the fifth-order harmonic components of the local signal appearing in the output of the quadrature modulating circuit 233 are made relatively larger. Hence, this embodiment is effective in this case.

FIG. 7 shows a modification of the second embodiment. This transformation does not include the low-pass filter but uses two notch filters NTF1 and NTF2 as the filter circuit 236 located at a subsequent stage of the quadrature modulating circuit 233. One of the notch filters NTF1 and NTF2 is served to cut off the third-order harmonics, while the other notch filter is served to cut off the fifth-order harmonics. In a case that the transistors composing the quadrature modulating circuit 233 and the transistors composing the phase-shift circuit 255 offer excellent frequency characteristics, the third-order and the fifth-order harmonics of the local signal in the output of the quadrature modulating circuit 233 are made larger and the other type of noises are made smaller. Hence, this embodiment is effective in this case.

### Third Embodiment

FIG. 8 shows the third embodiment of the present invention. In this embodiment, the filter circuit 236 located at a later stage of the quadrature modulating circuit 233 is composed of one low-pass filer LPF, one notch filter NTF1 for removing the second-order harmonics, and the other notch filter NTF2 for removing the third-order harmonics.

The variation in production may cause the symmetry of the quadrature modulating circuit 233 and the phase-shift circuit 255 to be inferior or cause the specific accuracy of the elements composing the quadrature modulating circuit 233 or the elements composing the phase-shift circuit 255 to be degraded. In this case, the second-order harmonic components of the local signal relatively conspicuously appears in the output of the quadrature modulating circuit 233. When the second-order harmonic components appear in the output, the inter-modulation between the second-order and the third-order harmonic components causes the waveform of the fundamental wave to be distorted. In order to overcome this shortcoming, this embodiment is effective in this case.

As another modification of this embodiment, it is considered as follows. The low-pass filter LPF as shown in FIG. 8 is replaced with the notch filter for removing the fifth-order harmonics and the filter circuit 236 composed of the notch filters for removing the second-order, the third-order and the fifth-order harmonics is located at a subsequent stage of the quadrature modulating circuit 233.

FIG. 9 shows a circuit of the quadrature modulating circuit (modulation & frequency converting circuit) composed of mixers for orthogonally modulating and upconverting the I and the Q signals of the transmission signal. This circuit is a type of a so-called Gilbert cell circuit.

As shown in FIG. 9, the quadrature modulating circuit of this embodiment includes a first mixer MIXa, which is arranged to have a pair of upper differential transistors Q11 and Q12, each having a source terminal grounded and a gate terminal inputted with an I signal and an /I signal, and two pairs of upper differential transistors Q21, Q22 and Q23, Q24, each pair having a common emitter connected with each drain terminal of these transistors Q11 and Q12 and a base terminal inputted with high frequency local signals φTX1 and /φTX1 sent from a transmitting PLL circuit 254, the collectors of Q21 and Q22 being connected with each other, and the collectors of Q23 and Q24 being connected with each other.

Moreover, the quadrature modulating circuit includes a second mixer MIXb, which is arranged to have a pair of lower differential transistors Q13 and Q14, each having a source terminal grounded and a gate terminal inputted with a Q signal and a /Q signal, and two pairs of lower differential transistors Q25, Q26 and Q27, Q28, each pair having a common emitter connected with the drain terminals of the transistors Q13 and Q14 and a base terminal inputted with local signals φTX2 and φTX2, these local signals being produced by shifting the local signals φTX1 and /φTX1 sent from the transmitting PLL circuit 254 by 90 degrees in the phase-shift circuit 255, the collectors of Q25 and Q27 being connected with each other, and the collectors of Q27 and Q28 being connected with each other.

The first mixer MIXa operates to multiply the I and /I signals being inputted into the lower differential section by the local signals φTX1 and /φTX1 being inputted to the upper differential section and then to output the signal containing the signal components corresponding to the frequency sum and the frequency difference of these signals as the differential signal from the common collector of Q21 and Q23 and the other common collector of Q22 and Q24. Further, the second mixer MIXb operates to multiply the Q and the /Q signals being inputted into the lower differential section by the local signals φTX2 and /φTX2 being inputted into the upper differential section, and then output the signal containing the signal components corresponding to the frequency sum and the frequency difference of these signals as the difference signal from the common collector of Q25 and Q27 and the other common collector of Q26 and Q28.

Moreover, the quadrature modulating circuit of this embodiment is arranged to connect each collector of the upper differential transistors Q22, Q24, Q26 and Q28 with the supply voltage Vcc through a common resistor Rc1 and to connect each collector of the upper differential transistors Q21, Q23, Q25 and Q27 with the supply voltage Vcc through a common resistor Rc2. In this arrangement, the quadrature modulating circuit outputs the synthesized signal of the output signals of the first mixer MIXa and the second mixer MIXb. In addition, with respect to the synthesized signal outputted from the quadrature modulating circuit, the signal component corresponding with the frequency difference is attenuated and the signal component corresponding with the frequency sum is amplified.

In this embodiment, the local signals φTX1, /φTX1 and φTX2, /φTX2 are inputted as square waves into the base terminals of the transistors Q21 to Q28 of the upper differential section. These local signals cause the transistors Q21 to Q28 to be quickly switched. On the other hand, the I and /I signals and the Q and /Q signals to be inputted into the gate terminals of the transistors Q11 to Q14 of the lower differential section are not so square as the local signals φTX1˜/φTX2. These signals cause the transistors Q11 to Q14 to be switched at a slower speed than the transistors Q21 to Q28. This slower switching allows the mixture of the noises contained in the local signals φTX1˜/φTX2 with the output of the mixer to be avoided. The third-order or the fifth-order harmonics appearing in the output, brought about by the use of the square waves as the local signals φTX1˜/φTX2, may be removed by the notch filters provided in the filter circuit 236. This results in improving the total characteristics and thereby making the distortion of the output waveform smaller.

The invention made by the present inventors has been concretely described along the embodiments. In actual, however, it goes without saying that the present invention is not limited to the foregoing embodiments and thus may be modified in various forms without departing from the spirit of the invention. For example, the foregoing embodiment has been described so that the receiving system circuit 20 is the direct conversion system and is arranged to downconvert the receiving signal. In place, it may be the super heterodyne system and arranged to downconvert the receiving signal.

Further, the high frequency IC of the foregoing embodiment has been described so that it may be arranged to modulate or demodulate the WVDMA system signal. In place, the present invention may be applied to the high frequency IC that is arranged to modulate or demodulate the GSM, DCS or PCS system signal or the high frequency IC that is arranged to make the modulation or demodulation of these four communication system signals possible. Moreover, the high frequency IC of the foregoing embodiment has been described so that the transmitting system circuit and the receiving system circuit are formed on a single semiconductor chip. In place, the present invention may be applied to the high frequency IC in which both of the circuits may be formed on their respective semiconductor chips.

The foregoing description has mainly concerned with the application of the present invention made by the present inventors to the high frequency IC that is used for the radio communication system such as a portable phone belonging to the technical background of the invention. Of course, the application of the invention is not limited to the abovementioned case. It may be also applied to the general high frequency IC such as the IC for a wireless LAN that includes a direct upconversion system transmitting system circuit.

It should be further understood by those skilled in the art that although the foregoing description has been made on embodiments of the invention, the invention is not limited thereto and various changes and modifications may be made without departing from the spirit of the invention and the scope of the appended claims.

1. A communication semiconductor integrated circuit comprising:
a frequency converter circuit for mixing a transmission signal with a local oscillation signal having a higher frequency than said transmission signal and upconverting said transmission signal from a frequency band of a baseband to a transmission frequency band; and
a filter circuit located at a subsequent stage of said frequency converter circuit and having a notch filter for removing at least third-order harmonics of said local oscillation signal.

2. A communication semiconductor integrated circuit as claimed in claim 1, wherein said notch filter is an LC resonance type trap filter, and one or more inductance elements and capacitance elements composing said trap filter are formed on the same semiconductor chip as the elements contained in said frequency converter circuit.

3. A communication semiconductor integrated circuit as claimed in claim 1, wherein said filter circuit further includes a low-pass filter.

4. A communication semiconductor integrated circuit as claimed in claim 1, wherein said filter circuit further includes a notch filter for removing fifth-order harmonics of said local oscillation signal.

5. A communication semiconductor integrated circuit as claimed in claim 1, wherein said filter circuit further includes a notch filter for removing second-order harmonics of said local oscillation signal.

6. A communication semiconductor integrated circuit as claimed in any one of claim 1, further comprising a gain variable amplifier circuit, located at a subsequent stage of said frequency converter circuit, for amplifying said upconverted transmission signal and outputting the amplified signal, and wherein said filter circuit is located between said frequency converter circuit and said gain variable amplifier circuit.

7. A communication semiconductor integrated circuit as claimed in any one of claim 1, wherein said frequency converter circuit includes a quadrature modulating circuit provided with a Gilbert cell type mixer circuit and differential transistors located at an upper stage of said mixer circuit, and said local oscillation signal is applied into the control terminal of said differential transistors, and an I signal having the same in-phase component as the fundamental wave and a Q signal having the orthogonal component to the fundamental wave are applied into the control terminal of said differential transistor located at a lower stage of said mixer circuit.

8. A communication semiconductor integrated circuit as claimed in claim 7, wherein said local oscillation signal to be inputted into said mixer circuit is square waveform signal, and the waveform of said I and Q signals to be inputted into said mixer circuit is more round than the waveform of said square local oscillation signal.

9. A communication semiconductor integrated circuit as claimed in claim 8, further comprising an oscillator circuit for generating said local oscillation signal to be inputted into said local converter circuit; and a phase-shift circuit for shifting the phase of said local oscillation signal generated by said oscillator circuit to generate signals whose phases are shifted from each other by 90 degrees and then supplying said phase shifted signals to said mixer circuit, and
wherein said oscillator circuit and said phase-shift circuit are formed on the semiconductor chip as said frequency converter circuit.

10. A communication semiconductor integrated circuit as claimed in any one of claim 1, further comprising a receiving system circuit for demodulating said receiving signal and downconverting said demodulated signal into a signal of the baseband frequency, and wherein said receiving system circuit is formed on the same semiconductor chip as said frequency converter circuit.

11. A radio communication system comprising:
a communication semiconductor integrated circuit described in claim 10;
a signal processing semiconductor integrated circuit for generating said transmission signal to be mixed with said local oscillation signal and then supplying said generated transmission signal to said communication semiconductor integrated circuit;
a power amplifier circuit for power amplifying a signal outputted from said communication semiconductor integrated circuit;
an antenna for outputting said transmission signal amplified by said power amplifier circuit as a signal radio wave; and
a duplexer for separating a signal received by said antenna from said transmission signal to be outputted from said antenna; and
wherein said signal received by said antenna is applied into said receiving system circuit.
